(19) United States
(12) Patent Application Publication
(10) Pub. No.: US 2020/0171556 A1
(43) Pub. Date: Jun. 4, 2020

(54) PRE-TREATMENT FOR SOLID WASTE PRESS

(71) Applicant: ANAERGIA INC., Burlington (CA)

(72) Inventors: Sasha ROLLINGS-SCATTERGOOD, Fergus (CA); Yousif HIRMIZ, Waterdown (CA); Kevin Carl LUTES, Guelph (CA); Juan Carlos JOSSE, Aliso Viejo, CA (US)

(21) Appl. No.: 16/700,609

(22) Filed: Dec. 2, 2019

Related U.S. Application Data
(60) Provisional application No. 62/774,918, filed on Dec. 4, 2018.

(51) Int. Cl. B09B 3/00; C02F 3/28; B30B 9/02

(52) U.S. Cl. CPC B09B 3/00; B30B 9/02; C02F 3/28

(57) ABSTRACT

Waste, such as municipal solid waste (MSF) or a portion of MSW, is separated into a wet fraction and rejects in a press. The press produces a wet fraction and rejects. The wet fraction may be treated, for example by anaerobic digestion or compost to thereby divert waste from landfill. The waste is pre-treated by spraying water at high pressure against the waste while moving or mixing the waste. The pre-treatment increases the amount of cellulosic material, such as paper or cardboard, that passes into the wet fraction.

### CROSS-REFERENCE TO RELATED APPLICATIONS

This application claims the benefit of U.S. Provisional Patent Application No. 62/774,918, filed Dec. 4, 2018, which is incorporated herein by reference.

### FIELD

This specification relates to treating waste such as municipal solid waste (MSW) and source separated organics (SSO).

### BACKGROUND

Solid waste can be divided into various fractions distinguished, among other things, by how easily they can be biodegraded. The organic fraction is the part of the waste that is most easily biodegraded and may also be referred to as organic waste. The organic fraction is primarily made up of food waste, but may also include leaf and yard waste or other materials. The organic fraction is approximately 40% of ordinary municipal solid waste (MSW) after recyclables are removed.

Historically, organic waste was landfilled with other solid waste. However, the organic fraction of solid waste is the major cause of greenhouse gas emissions, leachate and odors in landfills. There is a general trend to divert organic waste for biological treatment, for example by anaerobic digestion (AD) or composting. Most biological treatment steps require some preprocessing of the waste such as debagging and sorting to remove large items such as bottles and cans. Certain biological treatments, such as some composting methods and high-solids slurry and wet (low solids) anaerobic digestion, also require that the waste be reduced in size and homogenized. The size reduction is typically done in a device that comminutes the waste, such as a hammer mill, shredder or pulper. In some cases, the comminuting device also provides a coarse separation of contaminants (i.e. material that is not readily biodegraded, such as plastic). Alternatively, a separate separation device may be added.

Wet anaerobic digestion is typically performed in one or more mixed tanks. These systems are entirely contained and so allow for high levels of odor control and biogas recovery. In many cases, the organic waste can also be co-digested with wastewater treatment plant (WVVTP) sludge by modifying existing WVVTP digesters rather than building new facilities.

US Publication 2013/0316428 describes an alternative process in which an organic fraction containing biological cells is separated from solid waste in a press. The organic fraction is extruded through a grid having small-bore holes, under a pressure higher than the burst pressure of the cell membranes. The cells are disrupted and a gel or paste of a doughy consistency is produced. The gel can be digested in an anaerobic digester. The press may be as described in European Publication Nos. 1207040 and 1568478 and Italian patent publication ITTO20111068. In general, these presses use a plunger to compress waste that has been loaded into a cylinder. The sides of the cylinder are perforated with radial holes. US Publication 2013/0316428, European Publication Nos. 1207040 and 1568478 and Italian patent publication ITTO20111068 are incorporated herein by reference.

U.S. Pat. No. 8,877,468 describes a process in which materials containing lignocellulose are treated by pyrolysis under conditions (low temperature and long residence time) that favour the production of a liquid containing organic acids and alcohols. This liquid is suitable for conversion to biogas (primarily methane) in an anaerobic digester. U.S. Pat. No. 8,877,468 is incorporated herein by reference.

### INTRODUCTION

This specification describes a system and process for treating solid waste, for example municipal solid waste (MSW), separated streams derived from MSW, source separated organics or commercial recycling.

The inventors have observed that methods as described above do not divert large amounts of MSW from landfill in all cases. Comminuting devices treating MSW do not, generally speaking, produce high quality products. Presses may divert, for example, 20-30% of the mass of mixed MSW for efficient anaerobic digestion, but this still leaves a large portion of the MSW for landfill.

In a process described herein, solid waste is pre-treated and then separated in a press into a wet fraction and rejects. The wet fraction is treated in an anaerobic digester. The pre-treatment includes spraying water into the waste under pressure and/or mixing water with the waste. Cellulosic material in the solid waste becomes flowable in the press and is diverted into the wet fraction. Cellulosic material may include, for example, paper or cardboard.

A system described herein is adapted to perform a process as described above. The system includes a press and an anaerobic digester, for example a wet digester, to receive a wet fraction from the press. The system also includes a mixer or conveyor and a water spraying system upstream of the press.

### BRIEF DESCRIPTION OF THE FIGURES

FIG. 1 is a schematic drawing of a solid waste treatment system.

FIG. 2 is a graph of the % of solid waste recovered in the wet fraction (% WF) from press reject solids that were re-pressed after being pre-treated at various dilution ratios (mass solid waste:mass water added), spraying the press reject solids at high pressure in trials 1 and 3, shredding the press reject solids prior to pulping in trial five and adding the water at a low flow rate and a low pressure in trial four.

FIG. 3 is a graph of the % WF recovered from MSW fines pre-treated with water sprayed at high pressure at various dilution ratios, wherein the MSW fines are separated from two different size screens to produce MSW fines <8″ in trial 6 and MSW fines <2″ in trial 8.

FIG. 4 is a graph of the % WF recovered from two lignocellulosic feedstocks, dirty MSW sorted fibers (mostly dirty paper and sanitary products with minimal cardboard) in trial 7 and commercial recycling (mostly cardboard) in trial 10, wherein the solids are pre-treated at various dilution rations with water sprayed at high pressure.

FIG. 5 is a graph of the % WF recovered as a function of mixing time for MSW fines (<2″) at a dilution ratio of 1:0.5 in trial 9 and press rejects solids at a dilution ratio of 1:1 in trial eleven.

FIG. 6 is a graph of the % WF recovered from source separated organics pre-treated with water sprayed at high pressure at various dilution ratios.

FIG. 7 is a side view of a mixer in the form of a twin-screw conveyor with nozzles for spraying water.

FIGS. 8, 9 and 10 are cross sections of the mixer of FIG. 7.

### DETAILED DESCRIPTION

Recovery of large pieces of recyclable materials (i.e plastics, metals, cardboard and paper) from mixed municipal solid waste MSW is a well-established practice. There are several material recovery facilities (MRFs) that process mixed MSW as opposed to single stream waste, which is separated for recycling at the source. These facilities areknown in the industry as “dirty MRFs”. Several mechanical processes are used to recover recyclables from mixed waste. These processes include bag openers, shredders, screening, ballistic separators, wind sifters, optical sorters, magnets, Eddy Current separators, and manual sorting. Removing and then recycling metals, paper and plastics results typically in 10 to 15% diversion of mixed MSW from landfill. Similarly, municipal programs that involve separating recyclable materials at the source (for example in households or businesses prior to collection of the MSW) divert some solid waste from landfill.

MSW also contains food waste and other organic materials. Typically the vast majority of the food waste contained in MSW passes through 6 to 10-inch (coarse) trommel or disc screens, along with other materials that do not have recycling value or that escaped the recycling process upstream in a dirty MRF or at the source. These materials include mixed and soiled paper, broken glass, textiles, grit and stones, wood, plastic film, and small size ferrous and non-ferrous metals. Paper and other fibers can account for as much as 20 to 30% of the coarse screening underfraction of MSW from communities with source separation.

Wet organics can be recovered from the mixed MSW underfraction using an extrusion press as described for example in the patent publications described in the background section above. The coarse screen underfraction is suitable to feed to one or more commercially available presses such as an Organics Extrusion Press OREX 400, 500 or 1000 press sold by Anaergia. The extrusion press applies pressure on the waste in a confined extrusion chamber that contains perforations. A portion of the organic waste fluidizes under pressure and exits through the orifices to produce a paste-like material. This paste-like material, which may be called a wet fraction, is a suitable feedstock for anaerobic digestion (AD) or composting. The balance of the material fed to the press exits as rejects. Organics recovery for digestion achieve by way of the press provides an additional 20 to 30% diversion in typical North American mixed MSW.

However, many municipalities throughout North America and other parts of the world desire higher diversion of MSW from landfill than what traditional “dirty MRF” or source separated recycling can achieve even when coupled with organics extraction for AD or composting. While the press rejects could be further processed into refuse derived fuel (RDF) for use as fuel for power generation or cement kilns, thermal solutions such as this are not accepted as landfill diversion in many communities, for example because of the carbon dioxide or other emissions associated with these applications.

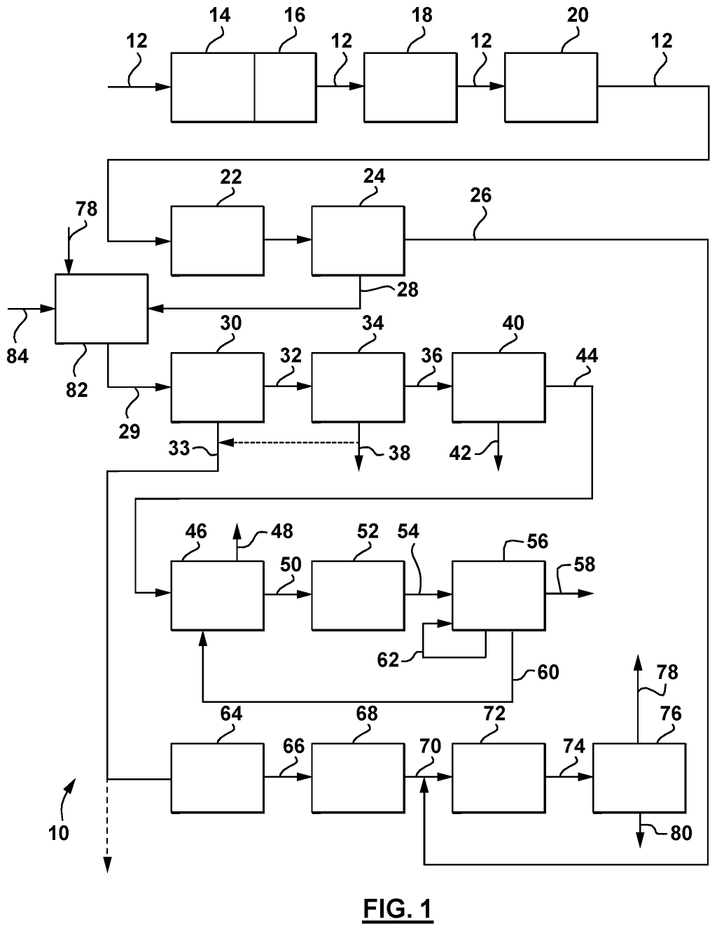

In the absence of pre-treatment, the press rejects can contain up to 40% of paper and pulpable fibers with no conventional recyclable value. However, this cellulosic material is digestible. In the system describe below, the solid waste is pre-treated before it is fed to the press. The pre-treatment increases the amount of cellulosic material that passes into the wet fraction of the press. Although the system described below is a dirty MRF system treating mixed MSW, the pre-treatment and following steps may also be applied to other forms of solid waste. Other forms of solid waste may include, for example, MSW that has had dry recyclable materials (i.e. cardboard, paper and plastics) removed at the source, source separated organics (SSO) such as kitchen waste separated at households or businesses, commercial recycling or press rejects returned back to the press. Such solid waste, or mixtures of solids waste, may be treated as if they were coarse screen underfraction in a dirty MRF system as described in the example of FIG. 1 below. In other alternative systems, the wet fraction produced from a press is composted, applied to land or otherwise diverted from landfill.

FIG. 1 shows a system 10 for treating solid waste 12. Solid waste 12, which may be for example municipal solid waste (MSW), is collected in trucks and dumped in piles in a tipping floor or pit 14. A loader or grapple places the waste into a dosing feeder 16 that feeds waste 12 into the processing line conveyor at a generally consistent rate suitable for the downstream processes. The waste 12 travels on the conveyor through a pre-sorting area 18. In the pre-sorting area 18, large un-bagged bulky items and other non-processible materials (such as furniture, rolls of chainlink fence, carpets, toilet bowls, etc. are manually removed from the conveyor.

The waste 12 continues from the pre-sorting area 18 and drops into a bag opener 20. The bag opener 20 opens plastic garbage bags. For example, the bag opener 20 may use a coarse tearing shredder, for example a single or double shaft shredder with a 200 mm spacing, to open the bags. The waste 12 with opened bags is then placed on another conveyor.

The waste 12 continues on the conveyor below an over-belt magnet 22 to remove large ferrous metal items. The waste 12 then passes through a coarse screen 24. The coarse screen 24 may be, for example, a disc, trommel or roller screen with 50-250 mm or 50-150 mm openings. The coarse screen 24 retains some of the waste 12, for example about 30-40%, as coarse screen overs 26. The screen overs 26 contain mostly large, generally dry, items of waste. The remaining 60-70% of the waste 12 passes through the coarse screen 24 and becomes coarse screen unders 28. The coarse screen unders 28 (alternatively called a screen underfraction) contains mostly wet or organic matter such as food waste, small containers and some inerts. In an efficient coarse screening process, about 95% of food waste in the waste 12 may end up in the coarse screen unders 28.

The screen overs 26 contain most of the recyclable materials in the waste 12. Some of the recyclable material can be extracted, for example with optical sorters or ballistic separators or other equipment. In the further description below, the screen overs 26 are assumed to have conventionally recyclable material, which may include some paper, removed from them by such equipment. However, even after recovering recyclable materials from the screen overs 26, including conventionally recyclable paper, there is still wet, mixed and dirty paper and possibly other cellulosic material left in the screen overs 26. The remaining paper has low recyclable value, for example because it is not economical to recover and use for making recycled paper by conventional techniques. However, as will be described below, a portion of the overs containing remaining paper and possibly other cellulosic material can be treated with the coarse screen unders 28.

The coarse screen unders 28 pass through a mixer 82. The mixer 82 may be, for example, a vertical screw compost mixer or a single or double screw conveyor. While the coarse screen unders 28 are in the mixer, they are sprayed with water 84, optionally at high pressure. The amount of water added to the coarse screen unders 28 may be, for example, between 0.25 to 1.25 times the mass of the coarse screen unders 28. The pressure of the water as it is pumped to a spraying head or nozzle may be at least 5, 6, 7, 8, 9, 10, 11, 12, 15, 20, 30, 40, 50, 60, 70, 80, 90, 100, 110, 120, 130, 140, 150, 160, 170, 180, 190, 200, 210 or 230 bar or more. In some examples the pressure may be in the range of 2500-3500 psi. The water may be sprayed manually, for example from a pressure washer, or from a spraying system that is not connected to the mixer. The spray may be provided from a continuous stream rather than a pulsed stream as in a pressure washer. Optionally, a plurality of nozzles may be mounted on in the mixer and connected to a system of pumps and pipes to provide a mixer with an integrated spraying system. Optionally, substantially all, for example 80% or more or 90% or more, of the water is retained in the coarse screen unders 28. Pre-treated solid waste 29 is extracted from the mixer 82.

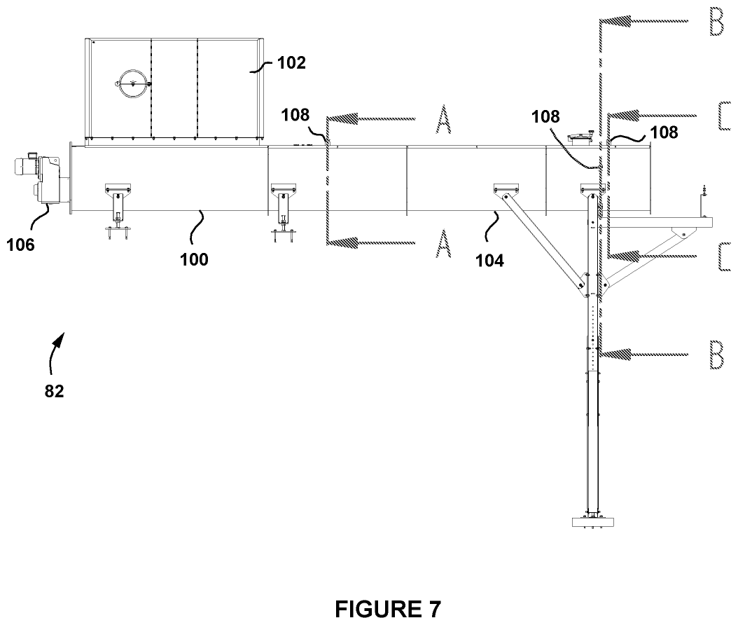

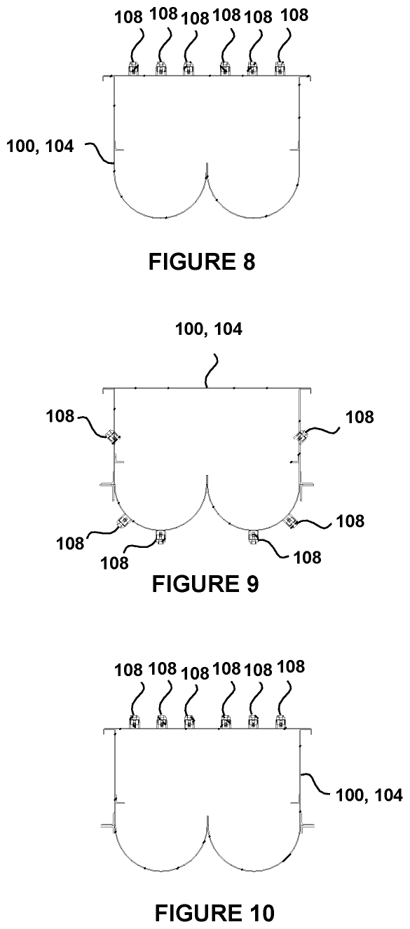

FIGS. 7-10 show an example of a mixer 82. In this example, the mixer 82 is in the form of a double screw conveyor 100. A hopper 102 receives the coarse screen unders 82 at one end of the conveyor 100 and feeds them into the screw body 104. The other end of the conveyor is connected to a press 30 (see FIG. 1, not shown in FIGS. 7-10) discussed further below. The screw body 104 contains two screws, or augers, driven by a motor 106 to convey the coarse screen unders 82 from the hopper 102 to the press 30. The two screws, which may be co-rotating or counter-rotating, also mix the coarse screen unders 82. Water is sprayed into coarse screen unders 82 as it moves through the conveyor 100 from nozzles 108. The nozzles 108 may be, for example, solid stream nozzles in the range of 5-20 mm in diameter. The nozzles 108 may be dispersed along the length of the conveyor 100, around a cross section of the conveyor 100, or both. In the example shown, the nozzles 108 are placed at three positions (sections A-A, B-B and C-C) along the length of the conveyor 100. At each position, nozzles 108 are dispersed around the cross-section of the conveyor 100 as shown in FIGS. 8-10. The screws are omitted from FIGS. 8-10 to simplify the drawing, but would be located with the lower half of each screw in one of the semi-circular depressions at the bottom of the conveyor 100.

The pre-treated solid waste 29 is treated in a press 30. The press 30 compresses the pre-treated solid waste 29 at high pressure in an enclosed extrusion chamber where the organic fraction is extruded through small perforations. For example, the pressure may be at least 50 bar, or at least 200 bar, or otherwise sufficient to mobilize the organic material and cellulosic material through the perforations. The perforations may be, for example, 4 to 20 mm or 4 mm to 8 mm diameter circular holes. The press 30 separates the pre-treated solid waste 29 into a wet fraction 32, which passes through the perforations, and rejects 33 that remain in the extrusion chamber after compression. The wet fraction 32 contains soluble organic compounds, cellulosic material and particulate material.

The press 30 may be as described in International Publication Number WO 2015/053617, Device and Method for Pressing Organic Material Out of Waste, or as described in European Publication Nos. 1207040 and 1568478, all of which are incorporated herein by reference. Suitable presses include presses sold by DB Italy (formerly VM Press) and DB Technologies or their parent company Anaergia including the VM 2000 and the Organics Extrusion Press (OREX) 400, 500 and 1000 presses. Other presses may also be used.

The wet fraction 32 passes into a polisher 34. In the polisher 34, the wet fraction 32 is fed into a screen cylinder surrounding a rotor. Particles of organic matter in the wet fraction 32 are flung outward from a rotor by its rotating movement and centrifugal forces. The particles of organic material are discharged through perforations in the screen to a first discharge opening. Air flowing along the axis of the rotor carries lighter material past the perforations to a second discharge opening. The airflow may be created by the rotor blades or by a separate fan. The rotor blades may optionally also scrape the inside of the screen. In this way, lighter particles (particularly bits of plastic) are separated from the organic particles in the wet fraction 32. The polisher 34 thereby produces polished wet fraction 36 and floatables 38. The floatables 38 include small pieces of plastic and paper that would tend to collect at the top of an anaerobic digester. A suitable polisher 34 is described in International Publication Number WO 2015/050433, which is incorporated herein by reference. A similar polisher is sold as the DYNAMIC CYCLONE by DB Technologies. Floatables 38 can be sent to landfill or optionally combined with rejects 33.

The polished wet fraction 36 is treated in a grit removal unit 40. The grit removal unit 40 preferably includes a hydro-cyclone. Water may be added if required to dilute the polished wet fraction 36 to bring its solids content to or below the maximum solids content accepted by the grit removal unit 40. However, the water 84 added to mixer 82 may already be sufficient such that no further dilution is required. The grit removal unit 40 removes grit 42 that is large enough to settle in an anaerobic digester. Separated grit 42 is sent to landfill, optionally after rinsing it.

Degritted wet fraction 44 is sent to an anaerobic digester 46, alternatively referred to as a digester for brevity. The digester 46 may be a wet anaerobic digester. The digester 46 may have one or more mixed covered tanks. Suitable digesters are sold under the Triton and Helios trade marks by UTS Biogas or Anaergia. The digester 46 produces product biogas 48 which may, for example, be used to produce energy in a combined heat and power unit or upgraded to produce biomethane. The digester 46 also produces sludge 50.

Sludge 50, alternatively called digestate, is sent to a drying unit 52. In the drying unit 52, the sludge is treated in a mechanical dewatering unit, for example a centrifuge, filter press or screw press. The mechanical dewatering unit separates the sludge 50 into a waste liquid, which may be sent to a sanitary drain or treated on site for discharge or re-use, and a de-watered cake. The de-watered cake is sent to a sludge cake dryer to further reduce its water content. Preferably, the de-watered cake is formed into pellets 54. The pellets 54 may be transported, for example, by screw conveyors or in bags or bins.

Pellets 54 are sent to a pyrolysis reactor 56. The pyrolysis reactor 56 heats the pellets 54 in the absence or a deficiency of oxygen, to produce biochar 58, pyrolysis liquid 60 and pyrolysis gas 62.

The biochar 58 may be sold as a soil enhancer, sent to landfill or processed further, for example in a gasification plant to make syngas. Pyrolysis liquid 60, including condensed vapors, is recycled to anaerobic digester 46 as additional feedstock for digestion. Pyrolysis gas 62 may be sent back to the digester 46 or sent to a burner of the pyrolysis reactor 56 to provide heat for pyrolysis.

The temperature in the pyrolysis reactor 56 may be over 270 degrees C., over 300 degrees C., or over 320 degrees C. In some embodiments, the temperature in the pyrolysis reactor is less than 450 degrees C., or less than 400 degrees C. or less than 350 degrees C. The residence time may be 5-30 minutes, or 10-20 minutes.

Rejects 33, particularly rejects 33 that have low recyclables content and contain mostly inerts and glass, can be sent to landfill. Alternately rejects 33 are sent to a shredder 64. The rejects 33 emerge from press 30 as chunks having about 38-50% water by weight. The chunks may have an average volume of about 0.02 to 0.1 cubic meters. The shredder 64 may have, for example, a single shaft crusher or shredder. The shredder 64 breaks up the chunks and produces shredded rejects 66.

The shredded rejects 66 are sent to a vibrating screen 68. The vibrating screen 68 may have 30 mm to 50 mm openings. Inerts and remaining organic materials fall through screen vibrating screen 68 and may be sent to landfill. Vibrating screen overs 70 includes solids such as plastic bottles, bags and fabric. Aluminum cans may also be present in the overs. If so, an eddy current separator can be used to remove non-ferrous metals. A drum magnet may also be used to remove remaining small pieces of ferrous material metal, if any.

Due to the action of the mixer 82, the vibrating screen overs 70 contain very little cellulosic material. However, the vibrating screen overs 70 may contain some cellulosic material, as well as other recoverable materials. The vibrating screen overs 70 are optionally combined with coarse screen overs 26. Optionally, the coarse screen overs 26 may have first passed through additional recyclable recovery units. Recyclables can be recovered, for example by manual separation, optical sorters or ballistic separators.

The combined overs 26, 70 pass through a wind sorter 72. In the wind sorter 72, air nozzles blow material from one belt to another over a gap. RDF fluff 74 flies over the gap. Dense material, i.e. rocks, falls into the gap and is sent to landfill. The RDF fluff 74 has about 25% moisture and contains plastic, paper, textiles, other dry fibers, etc.

The RDF fluff 74 goes to an optical sorter 76. The optical sorter 76 separates plastic and other non-cellulosic material from cellulosic material such as paper. Near infrared sensors determine if matter is cellulosic or not. Air jets then separate the RDF fluff 74 into cellulosic fluff 78 and non-cellulosic 80 fluff with about 85-95% efficient separation. Optionally, multiple optical sorters 76 may be used in series. The extracted cellulosic fluff 78 can have 80% or more purity when one optical sorter 76 is used and 85% or more purity with two optical sorters 76 are used in series.

In an alternative embodiment, the combined overs 26, 70 pass through the optical sorter 76 before passing through the wind sorter 72. In this case, sensors locate cellulosic matter in the combined overs 26, 70 and air jets separate the cellulosic matter, which is cellulosic fluff 78, from the combined overs 26, 70. Non-cellulosic fluff 80 is then separated from the remainder of the combined overs 26, 70 in the wind sorter 72.

In other embodiments, one or both of the vibrating screen overs 70 and coarse screen overs 26 are processed separately, for example as described for combined overs 26, 70, to separate cellulosic fluff 78. If vibrating screen overs 70 and coarse screen overs 26 are both processed to separate cellulosic material separately, the cellulosic fluff 78 from both streams may be combined and treated together or be treated separately.

Non-cellulosic fluff 80 is sent off-site. The non-cellulosic fluff 80 could be combusted to recover heat energy or converted to bio-oil by pyrolysis. If pyrolysis is used, this may be a high temperature, low residence time process that emphasizes the production of long chain hydrocarbons. Bio-oil produced from plastics in this way is useful in making fuels but toxic to microorganisms in digester 46 unless very high temperatures are used.

Some or all of the cellulosic fluff 78 is optionally recycled to the mixer 82 and then to press 30 and digester 46.

Optionally, one or more further streams of digestible material, for example waste water treatment sludge, source separated organics or commercial or industrial food waste, may be added to the digester 46.

Bench scale trials were performed to determine if cellulosic material diverted from solid waste is digestible, alone or in combination with the wet fraction from a press treating the solid waste. For the trials, a mixture of paper types was made to simulate cellulosic material diverted from solid waste. The mixture contained 21% recyclable Kraft paper, 8% newspaper, 4% high-grade office paper, 28% mixed recyclable paper, 37% compostable paper and 3% non-recyclable paper. The paper samples were shredded, mixed together and then soaked in 13 mL of distilled water per gram of paper for 3 days. The paper and water were then blended with an immersion blender to a pulp.

Samples of mixed paper as described above were digested in a benchtop wet anaerobic digester alone and in combination with wet fraction from a press treating mixed solid waste. In Trial A, 1.46 g of paper was digested. In trial B, 0.54 g of wet fraction was digested. In Trial C, 1.46 g of paper and 0.54 g of wet fraction were digested together. After 14 days of digestion, the amount of methane produced was 337 mL in Trial A, 189 mL in Trial B, and 532 mL in Trial C. Since the methane production of Trial C is approximately equal to the sum of the methane production of Trials A and B, these results suggest that adding even significant amounts of paper did not create material toxicity or otherwise inhibit digestion of the wet fraction. The paper produces less methane per unit mass than wet fraction however the amount of methane produced by the paper, and in particular by paper and wet fraction blends, is within the range of workable digester designs.

Digestate from treating paper and a mixture of paper and wet fraction were passed through a 2 mm wire screen. No large pieces of undigested paper were retained on the screen from either sample. The digestate produced from paper only was flowable and was easily washed through the screen with excess water, but did not pass through the screen easily by gravity without adding wash water. The paper and wet fraction digestate flowed through the screen easily by gravity without adding wash water. While it is expected that both digestate samples could be dewatered in full scale equipment, the paper and wet fraction digestate might be easier to process.

In an example, mixed MSW (i.e. coarse screen underfraction from a dirty MRF facility) was pre-treated by mixing the waste with 75 tons of water per 100 tons of solid waste. The solid waste was placed in a vertical screw compost mixer. Water was sprayed on the waste from a hand held pressure washer equipped with a solid stream nozzle. The spray from the pressure washer was directed at the solid waste while the solid waste was moving in the mixer. The pre-treated waste was then pressed. Compared to pressing the same source of waste without the pre-treatment, the pre-treatment caused 30-40% more of the solid waste (an additional 30-40% of the weight of the solid waste before pressing) to be diverted to the wet fraction of the press.

In a comparative example, adding the same amount of water under low pressure with a hose (45 psi) did not cause as much diversion of solid material to the wet fraction. Pressure washers described in this application spray water at a pressure of 900-3500 psi, typically 2500-3500 psi. A continuous high pressure stream, rather than a pulsed stream as produced by a pressure washer, may also be used.

In another example, a stream of source separated organics (SSO) was pre-treated by mixing the waste with 35 tons of water per 100 tons of solid waste. The solid waste was sprayed with water from a hand held pressure washer while the solid waste was moving through a screw conveyor to the feed hopper of a press. The pre-treated waste was then pressed. In a control run without pre-treatment, 31% of the SSO by weight remained in the rejects of the press. With pre-treatment, only 18% by weight of the SSO remained in the rejects, indicating that at least an additional 13% of the SSO (an additional 13% of the weight of the SSO before pressing) had been diverted to the wet fraction of the press.

In other examples, solid waste was pre-treated before being pressed. In some cases the solid waste was pressed (in some case after passing through other process units such as a bag opener and screen) to produce press reject solids, and the press reject solids were pre-treated and sent back to the press. In other cases, the solid waste was pre-treated (in some case after passing through other process units such as a bag opener and screen) and then pressed for the first time.

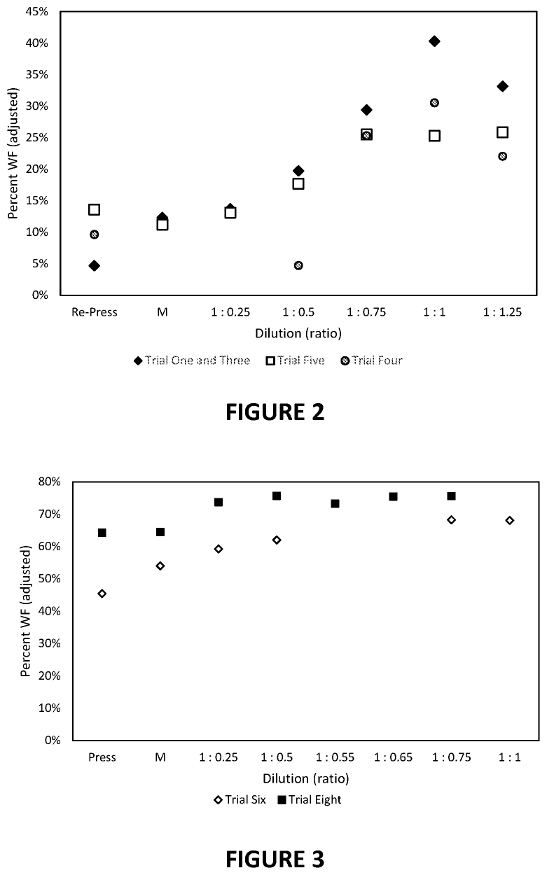

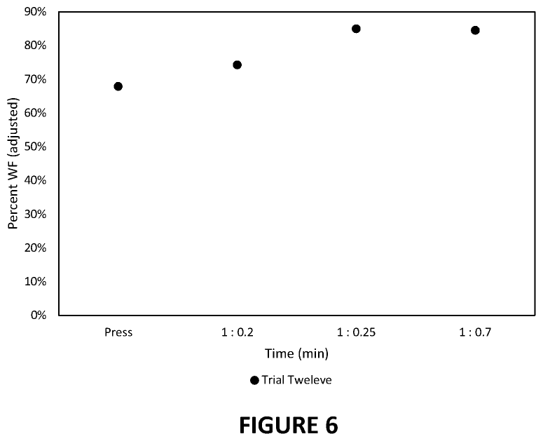

In various tests described in FIG. 2 to FIG. 6, several feedstock sources were used to examine the impact of pre-treatment. The feedstocks included municipal solid waste (MSW) fines screened at 8″ and under 2″, press reject solids from an OREX press, dirty MRF recovered fibers (i.e. paper and diapers), source separated organics (SSO), and commercial recycling (mainly cardboard). Table 1 shows the amount of water addition and dilution. Other than in trial four (water added at pressure <45 psi) and in trial five (solids shredded), the waste was pre-treated by spraying with a pressure washer (900-3000 PSI) while mixing the waste in a vertical screw compost mixer or screw conveyor. The trial conditions are summarized in Table 1.

TABLE 1
The feedstock, dilutions and objectives of trials one through twelve.

| | | Dilutions | |
|---|---|---|---|
| Trial # | Feedstock | (Solids:Water) | Comments |
| One | Press reject solids form | 1:0 | |
| | OREX 500 press | | |
| Two | Reject solids OREX 500 | 1:0 Mixed | mixer broke down and trial was |
| | | 1:0.5 Mixed | discontinued. |
| Three | Reject solids OREX 500 | 1:0 Mixed | |
| | | 1:0.25 | |
| | | 1:0.5 | |
| | | 1:0.75 | |
| | | 1:1 | |
| | | 1:1.25 | |
| Four | Reject solids OREX 500 | 1:0 | water added at low pressure |
| | | 1:0.5 | and low flow |
| | | 1:0.75 | |
| | | 1:1 | |
| | | 1:1.25 | |
| Five | Reject solids OREX 500 | 1:0 | waste shredded and mixed with |
| | | 1:0 Mixed | water |
| | | 1:0.25 | |
| | | 1:0.5 | |
| | | 1:0.75 | |
| | | 1:1 | |
| | | 1:1.5 | |
| Six | MSW fines (<8″) | 1:0 | |
| | | 1:0 Mixed | |
| | | 1:0.25 | |
| | | 1:0.5 | |
| | | 1:0.75 | |
| | | 1:1 | |
| Seven | fibers recovered from MSW | 1:1 | |
| | (i.e. paper and diapers) | 1:4 | |
| Eight | MSW fines | 1:0 | |
| | | 1:0 Mixed | |
| | | 1:0.25 | |
| | | 1:0.5 | |
| | | 1:0.55 | |
| | | 1:0.65 | |
| | | 1:0.75 | |
| Nine | MSW fines (<2″) | 1:0 | trials with different mixing times |
| | | 1:0.5 | |
| Ten | Commercial | 1:0 | |
| | recycling | 1:4 | |
| | | 1:5 | |
| Eleven | Reject solids OREX 500 | 1:1 | trials with different mixing times |
| Twelve | Source separated organics | 1:0 | |
| | | 1:0.2 | |
| | | 1:0.25 | |
| | | 1:0.7 | |

The results in FIGS. 2-6 and Table 2 indicate that adding water to all types of waste (MSW, SSO, lignocellulosic recycling, and press reject solids) prior to pressing leads to an increase in the percentage of waste that is recovered in the wet fraction (% WF), that is an increase in the recovery of organics from the waste. Without intending to be limited by theory, water addition under pressure may help the press mobilize the organic solids in the feed and increase their recovery as part of the wet fraction (WF). Increased wet fraction reduces the amount of reject solids, increases waste diversion, and increases the overall biogas potential of waste.

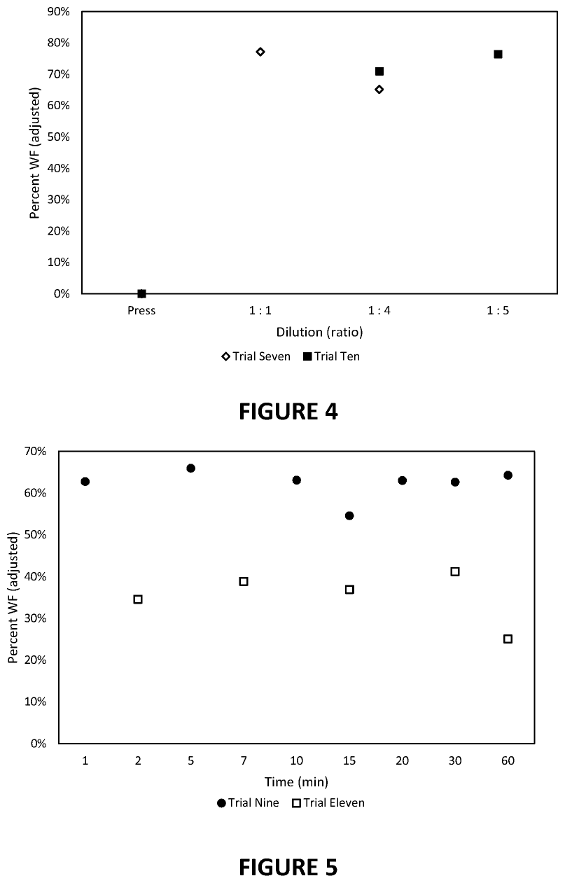

Pre-treatment also allows pressing of feedstocks other than MSW and SSO. A 77% and a 67% increase in % WF recovery was measured after pretreatment for commercial recycling and recovered fibers (sorted paper and sanitary products) respectively, as shown in Table 2 and FIG. 4. Both sorted paper, and commercial recycling (mainly carboard) are highly organic feedstocks that can be diverted from landfills and used to generate biogas through this process. Although material such as cardboard is dry (high % TS) and hard (lignocellulosic fibers), it may be converted into a putrescible organic stream with pre-treatment. Similarly, pre-treatment increases the % WF recovery when pressing press rejects (produced for example by pressing MSW), SSO, and MSW fines. The waste streams include lignocellulosic solids that end up as part of the reject solids when pressed without pre-treatment. Pre-treatment may help break down materials containing lignocellulosic fibers and allow the press to mobilize them to be diverted to the press WF stream. The increase in % WF recovery was highest for the lignocellulosic feedstock (77%), followed by MSW reject solids that are mainly made up of plastics and lignocellulosic material (35%), MSW fines (23%), and source separate organics (17%). This is the same order that these feedstocks would be placed in if ordered based on lignocellulosic content.

Pre-treatment including water addition and mixing also appears to help wash off organics from the surface of plastics. The plastics remain in the press rejects while the washed-off organics are recovered as part of the WF stream. This was physically observed when testing. The plastic film, plastic containers, metal and glass became visibly cleaner as the water addition increased. Water addition had a washing effect on reject solids, MSW fines, and SSO.

Water added at a higher impact force, for example from a pressurized sprayer, resulted in a higher % WF recovery. To compare, water was added to an SSO feedstock at both a low pressure (0 psi) and a low flow rate using a small 5-gallon bucket, and at a high pressure and a low flow rate using a pressure washer. At the same dilution, the percent % WF recovery was lower by 10% (10% of the original weight of the SSO before treatment) when water was added using a bucket. Similar findings with MSW rejects, when water was added at a low flow rate and a low pressure as a mist in trial four, the % WF recovery was highly reduced in comparison to trial three at all dilutions, FIG. 2. Spraying water using a high impact force may help shear the solids (i.e. lignocellulosic solids) and/or may improve water absorption, thereby increasing % WF recovery.

Mixing moistened waste may shear some solids or help distribute the water (water settles to the bottom without the mixer) and create a uniform feedstock. Although some mixing improved the % WF recovery for all feedstocks, mixing times of over 1 or 2 minutes had minimal additional effect, FIG. 5. However, mixing is useful for to facilitate the addition and distribution of water.

The amount of water that resulted in the highest % WF recovery varied depending on the feedstock. The plateau in the Figures represents the point of maximum % WF recovery. The lowest dilution in that plateau may be an optimum point wherein % WF recovery is maximized with the least amount of water. For commercial recycling solids, that optimum was measured at a solid to water dilution ratio of 1 to 4, 1 to 1 for sorted paper and sanitary products, 1 to 1 for reject solids, 1 to 0.75 for MSW fines smaller than 8″, 1 to 0.5 for MSW fines smaller than 2″, and 1 to 0.25 for SSO. Again, the various feedstocks are in an order seen earlier, that is the dilution ratio increases with an increasing lignocellulosic content. Lignocellulosic solids can be very dry and have the capacity to absorb water. Additionally, the starting moisture content of the various feedstock differs, and the feedstocks would follow a similar order if arranged based on increasing moisture content.

In Table 2, the percent wet fraction yield (% WF) (as a percentage of the original weight of the solid waste) for trials one through twelve is organized based on feedstock. The % WF values were adjusted by subtracting the weight of water added such that the values listed only consider the solids recovered in the WF. This was done based on the assumption that essentially all of the water added is recovered as part of the WF stream. The unadjusted % WF recovery is higher.

TABLE 2
Percent WF (adjusted)

| | Dilution | Trial One & Three | Trial Five | Trial Four |
|---|---|---|---|---|
| Reject Solids | Re-Press | 5% | 14% | 10% |
| | M | 12% | 11% | #N/A |
| | 1:0.25 | 14% | 13% | #N/A |
| | 1:0.50 | 20% | 18% | 5% |
| | 1:0.75 | 29% | 26% | 25% |
| | 1:1.00 | 40% | 25% | 31% |
| | 1:1.25 | 33% | 26% | 22% |

| | Dilution | Trial Six | Trial Eight |
|---|---|---|---|
| MSW Fines | Press | 45% | 64% |
| | M | 54% | 64% |
| | 1:0.25 | 59% | 74% |
| | 1:0.50 | 62% | 76% |
| | 1:0.55 | #N/A | 73% |
| | 1:0.65 | #N/A | 75% |
| | 1:0.75 | 68% | 76% |
| | 1:1.00 | 68% | #N/A |

| | Dilution | Trial Seven | Trial Ten |
|---|---|---|---|
| Lignocellulosic | Press | 0% | 0% |
| | 1:1 | 77% | #N/A |
| | 1:4 | 65% | 71% |
| | 1:5 | #N/A | 76% |

| | Time (min) | Trial Nine | Trial Eleven |
|---|---|---|---|
| Mixing Time | Press | 49% | 5% |
| | 1 | 63% | #N/A |
| | 2 | #N/A | 35% |
| | 5 | 66% | #N/A |
| | 7 | #N/A | 39% |
| | 10 | 63% | #N/A |

| Dilution | Trial One & Three | Trial Five | Trial Four |
|---|---|---|---|
| 15 | 55% | 37% | |
| 20 | 63% | #N/A | |
| 30 | 63% | 41% | |
| 60 | 64% | 25% | |

| | Dilution | Trial Twelve |
|---|---|---|
| Source Separated Organics | Press | 68% |
| | 1:0.2 | 74% |
| | 1:0.25 | 85% |
| | 1:0.7 | 85% |

Pretreatment as described herein may be useful for one or more of increasing waste diversion, decreasing the moisture content of waste reject solids (which may produce less odor), increasing the biogas production potential of solid waste, increasing the variety of feedstocks (including commercial recycling) that may be treated in an anaerobic digester, or increasing the incinerator or thermal value of reject solids.

In International Publication Number WO 2018/129616 A1, Solid Waste Processing with Diversion of Cellulosic Waste, the Applicant describes a process in which waste such as MSW is separated into a wet fraction and rejects. For example, the waste may be separated in a press. A cellulosic fraction is separated from the rejects, for example in a pulper or with an optical sorter. The cellulosic fraction is treated in an anaerobic digester, optionally with the wet fraction. International Publication Number WO 2018/129616 A1 is incorporated herein by reference.

We claim:

1. A process comprising steps of,
adding water under high pressure to solid waste;
mixing the water and solid waste; and,
pressing the mixture to separate a wet fraction of the mixture from rejects.

2. The process of claim 1 comprising treating the wet fraction by anaerobic digestion or composting.

3. The process of claim 1 wherein the step of pressing the mixture comprises pressing at a pressure of 50 bar or more or 200 bar or more.

4. The process of claim 1 wherein the waste comprises municipal solid waste or a portion of municipal solid waste.

5. The process of claim 1 wherein the water is sprayed at a pressure of 5 bar or more or 8 bar or more.

6. The process of claim 1 wherein water is added to the solid waste in a range from 25 tons to 125 tons per 100 tons of solid waste.

7. The process of claim 1 wherein water is added to the solid waste in a range from 25 tons to 50 tons per 100 tons of solid waste and the solid waste is source separated organics.

8. The process of claim 1 wherein water is added to the solid waste in a range from 50 tons to 100 tons per 100 tons of solid waste and the solid waste is post-recycling municipal solid waste or mixed municipal solid waste.

9. The process of claim 1 wherein the steps of adding water and mixing at least partially overlap in time.

10. The process of claim 1 wherein the waste is mixed while adding water.

11. A solid waste treatment system comprising,
a press;
a mixer or conveyor; and,
a high pressure water sprayer in communication with the mixer or conveyor,
wherein the mixer or conveyor is upstream of the press.

12. The system of claim 11 wherein the high pressure water sprayer is integrated with the mixer or conveyor.

13. The system of claim 11 comprising an anaerobic digester configured to receive a wet fraction separated by the press.
